(19) United States
(12) Patent Application Publication
(10) Pub. No.: US 2009/0091681 A1
(43) Pub. Date: Apr. 9, 2009

(54) LIQUID CRYSTAL DISPLAY DEVICE

(76) Inventors: Shigeki NISHIZAWA, Mobara (JP); Tsutomu Sato, Mobara (JP); Yuuji Oomori, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/244,086

(22) Filed: Oct. 2, 2008

(30) Foreign Application Priority Data
Oct. 3, 2007 (JP) 2007-259334

(51) Int. Cl. G02F 1/1333

(52) U.S. Cl. 349/58

(57) ABSTRACT

A liquid crystal display device includes a frame-shaped first frame having an opening to expose an effective display area, the first frame having a curved shape having a predetermined curvature in one direction; a liquid crystal display panel including a pair of light-transmitting substrates that encapsulate liquid crystal molecules, each of the light-transmitting substrates having a pixel selection electrode on the inner surface thereof, the liquid crystal display panel disposed on the backside of the first frame so that the liquid crystal display panel faces the opening; a backlight disposed on the backside of the liquid crystal display panel and irradiating the backside of the liquid crystal display panel with light-source light, the backlight including a light guide plate, an optical compensation laminate, a frame-shaped resin frame, and at least one light source; and a second frame disposed on the backside of the backlight, the second frame having a curved shape having a curvature comparable to the curvature of the first frame. The liquid crystal display panel and the backlight are sandwiched between the first frame and the second frame and held and secured along the curved shape.

The present application claims priority from Japanese applications JP2007-259334 filed on Oct. 3, 2007, the content of which is hereby incorporated by reference into this application.

### BACKGROUND

1. Technical Field

The present invention is concerned with, for example, a liquid crystal display device suitably used in mobile phones, personal computers, televisions, and other device in which images are displayed on a curved surface. The invention particularly relates to a structure for maintaining the shape of a curved surface of a liquid crystal display panel in which images are displayed on the curved screen, and specifically to a curved shape maintaining structure for maintaining a convexly or concavely curved display surface of a liquid crystal display panel.

2. Related Art

A liquid crystal display panel that forms a liquid crystal display device is basically an image display device including first and second substrates preferably comprised of glass substrates and a liquid crystal layer encapsulated therebetween, and using a phenomenon in which the orientation of the liquid crystal molecules is changed in response to an electric field applied to the liquid crystal molecules from pixel selection electrodes formed on the substrates. A fully-transparent liquid crystal display device, which is currently most frequently used, has a structure in which light-source light projected from a backlight disposed on the backside of the liquid crystal display panel is polarized in the liquid crystal layer by approximately 90 degrees and the light passing through a polarizer forms an electronic latent image viewed as a visible image.

In a liquid crystal display device using a non-luminous liquid crystal display panel, an external illuminator is provided to make an electronic latent image formed on the liquid crystal display panel visible. As the external illuminator, except a structure using natural light, an illumination device is provided on the back side or the front side of the liquid crystal display panel. In particular, a display device required to be highly bright typically has a structure in which an illumination device is provided on the backside of the liquid crystal display panel. Such an illumination device is called a backlight.

A backlight is broadly classified into a side light-type backlight and an overhead light-type backlight. A side light-type backlight has a structure in which a linear light source, a representative example of which is a cold cathode fluorescent lamp, is disposed along a side edge of a light guide plate comprised of a transparent plate, and is frequently used in a display device required to be thin, such as a personal computer. On the other hand, in a large-sized liquid crystal display device, such as a display device used in a display monitor or a television receiver, an overhead light-type backlight is frequently used. An overhead light-type backlight has a structure in which an illumination device is disposed immediately under the backside of the liquid crystal display panel.

A liquid crystal display using a liquid crystal display device is widely used as a display terminal of a mobile information device, such as a notebook personal computer, a television, a mobile phone, and a personal digital assistant. Most of the liquid crystal displays currently used are formed by using glass substrates, and a liquid crystal display panel including a liquid crystal display device is required to have a lightweight, thin, flexible structure.

In recent years, as a mobile phone display in which images are display on a curved surface, there has been an increasing demand to develop a display whose display surface has a fixed radius of curvature. To this end, studies on a flexible liquid crystal display using plastic substrates are underway. Currently, however, many technical problems remain unsolved. In view of these circumstances, studies are underway to bend a current glass substrate-based liquid crystal display device (liquid crystal display panel) by making the thickness of the glass plates thinner using glass polishing.

In a flexible display in which polymer dispersed ferroelectric liquid crystal molecules are encapsulated between plastic substrates, for example, a flexible display structure using a flexible light guide plate in a backlight has been proposed. In this configuration, accuracy in a photolithography process is improved by employing a process in which a liquid crystal display device using plastic substrates is first fabricated on a glass substrate and then separated therefrom.

An exemplary flexible backlight is disclosed in H. Sato, H. Fujikake, S. Suzuki, D. Nakayama, T. Furukawa, H. Kikuchi, T. Kurita, (NHK, Japan, Minebea, Japan, Kyodo Printing, Japan), “A4-Sized LCDs with Flexible Light Guide Plate,” International Display Workshops (IDW) '06. The flexible backlight, in a comment when the flexible backlight was announced, had not been developed to display a curved image on a curved surface, but study a structure with improved impact resistance and future rollability.

Recent studies on flexible displays have been conducted based on an assumption that a thin-film transistor is formed directly or indirectly on a plastic substrate instead of a glass substrate currently used. However, developments of plastic substrates are still in the halfway stage to which volume production cannot be applied. It is therefore considered that as a temporal solution, glass polishing is used to make a glass substrate thinner to achieve curved surface display.

When a thin glass plate is used to form a liquid crystal display panel, the glass thickness is set to a value at which the thin glass plate can be bent to form a curved surface having a target radius of curvature with no problems. There is, however, a problem of necessarily using a flexible light guide plate in the backlight, which is a component of the liquid crystal display panel, as disclosed in H. Sato, H. Fujikake, S. Suzuki, D. Nakayama, T. Furukawa, H. Kikuchi, T. Kurita, (NHK, Japan, Minebea, Japan, Kyodo Printing, Japan), “A4-Sized LCDs with Flexible Light Guide Plate,” International Display Workshops (IDW) '06.

### SUMMARY

An advantage of some aspects of the invention is to provide a liquid crystal display device in which a liquid crystal display panel, a backlight, and components thereof are efficiently assembled into a curved shape and the radius of curvature of a display surface of the liquid crystal display panel is fixed to readily display images on the curved surface.

Another advantage of some aspects of the invention is to provide a liquid crystal display device in which the shape of a completed curved display surface of a liquid crystal display panel can be stably maintained over time for improved reliability.

Another advantage of some aspects of the invention is to provide a high-quality, reliable liquid crystal display device in which a completed curved display surface having a fixed radius of curvature can be maintained over time.

A liquid crystal display device according to an aspect of the invention comprises a frame-shaped first frame having an opening in a principal surface to expose an effective display area, the first frame having a curved shape having a predetermined curvature in one direction; a liquid crystal display panel including a pair of light-transmitting substrates that encapsulate liquid crystal molecules, each of the light-transmitting substrates having a pixel selection electrode on the inner surface thereof, the liquid crystal display panel disposed on the backside of the first frame so that the liquid crystal display panel faces the opening; a backlight disposed on the backside of the liquid crystal display panel and irradiating the backside of the liquid crystal display panel with light-source light, the backlight including a light guide plate, an optical compensation laminate, a frame-shaped resin frame, and at least one light source; and a second frame disposed on the backside of the backlight, the second frame having a curved shape having a curvature comparable to the curvature of the first frame. The liquid crystal display panel and the backlight are sandwiched between the first frame and the second frame and held and secured along the curved shape. The liquid crystal display panel and the backlight are therefore shaped into a curved form having a radius of curvature substantially comparable to those of the first and second frames and held and secured. The problems of related art can be thus solved.

It is preferable that in the above configuration, the first and second frames are formed into the curved shape having the predetermined curvature along the longitudinal direction of the liquid crystal display panel.

It is preferable that in the above configuration, the first and second frames are formed into the curved shape having the predetermined curvature along the short-side direction of the liquid crystal display panel.

It is preferable that in the above configuration, each of the first and second frames is comprised of a formed metal plate.

It is preferable that in the above configuration, each of the light-transmitting substrates is a glass substrate.

It is preferable that in the above configuration, the thickness of each of the pair of the glass substrates having the liquid crystal molecules encapsulated therebetween is 0.2 mm or smaller.

It is preferable that in the above configuration, the thickness of the light guide plate is 0.5 mm or smaller.

It is preferable that in the above configuration, the light source is a light emitting diode, and the light emitting diode is disposed at an end of the light guide plate.

According to some aspects of the invention, the liquid crystal display panel and the backlight are held and secured between the first frame and the second frame along a curved shape having a predetermined curvature in one direction. There is thus provided an extremely advantageous effect in which a liquid crystal display device in which images are displayed on a curved surface is efficiently achieved.

According to some aspects of the invention, the liquid crystal display panel and the backlight are sandwiched, held, and secured between the first frame and the second frame having a predetermined curvature in one direction. There is thus provided an extremely advantageous effect in which a liquid crystal display device whose display surface has a high-quality, reliable structure that allows a fixed radius of curvature can be achieved.

### BRIEF DESCRIPTION OF THE DRAWINGS

FIG. 1 is a perspective development showing a schematic configuration of a first example of a liquid crystal display device according to an aspect of the invention.

FIG. 2 is a perspective development showing the configuration of a backlight in a liquid crystal display device according to an aspect of the invention.

FIG. 3 is a diagrammatic perspective view showing an overall configuration of a liquid crystal display device according to an aspect of the invention.

### DESCRIPTION OF EXEMPLARY EMBODIMENTS

The best mode for carrying out the invention will be described below in detail with reference to the drawings of an embodiment.

### Embodiment

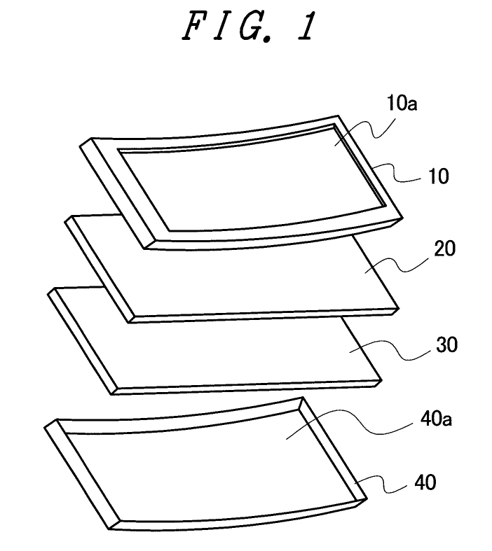

FIG. 1 is a perspective development of a key portion for explaining an embodiment of a liquid crystal display device according to an aspect of the invention. In FIG. 1, the liquid crystal display device includes an upper frame 10, which is a first frame, a liquid crystal display panel 20, a backlight 30, and a lower frame 40, which is a second frame, all of which are stacked on each other.

The upper frame 10 is comprised of, for example, a formed stainless plate having a thickness of approximately 0.2 mm. An opening 10a is formed in the upper side of the upper frame 10 and sized to expose an effective display area. The upper frame 10 is shaped into an upward concave curved frame having a radius of curvature of approximately 150 to 200 mm along the longitudinal direction.

On the other hand, the lower frame 40 is comprised of, for example, a formed stainless plate having a thickness of approximately 0.2 mm. A recess is formed in the lower frame 40, the recess having a bottom 40a and housing the liquid crystal display panel 20 and the backlight 30 on the upper surface of the recess. The lower frame 40 is shaped into an upward concave curved frame having a radius of curvature substantially comparable to that of the upper frame 10 in the longitudinal direction. The upper frame 10 and the lower frame 40 are assembled to face each other and held and secured.

The liquid crystal display panel 20 is comprised of a pair of light-transmitting glass substrates that sandwich a liquid crystal layer, the light-transmitting glass substrates formed into a flat shape, for example, having a total thickness of approximately 0.4 mm or smaller, preferably approximately 0.20 mm. Each of the pair of thin light-transmitting glass substrates may be formed by melting a thick glass plate in hydrofluoric acid, may be formed by mechanically polishing a thick glass plate into a thin glass plate, or may be comprised of a thin preformed glass plate. The overall shape of the liquid crystal display panel 20 is not curved but substantially flat.

The liquid crystal display panel 20 has pixel selection electrodes on the inner opposing surfaces of the pair of glass substrates and a pair of polarizers bonded onto outer surfaces thereof, and a liquid crystal layer is encapsulated between the pair of light-transmitting glass substrates. The peripheral edges of the opposing substrates are sealed with a sealing material. The orientation of the liquid crystal molecules is changed in accordance with an electric field applied from the pixel selection electrodes to the liquid crystal molecules. Light-source light projected from the backlight 30 disposed on the backside of the liquid crystal display panel 20 is polarized in the liquid crystal layer by approximately 90 degrees. The light passing through the polarizers forms an electronic latent image, which can be viewed on the display surface as a visible image.

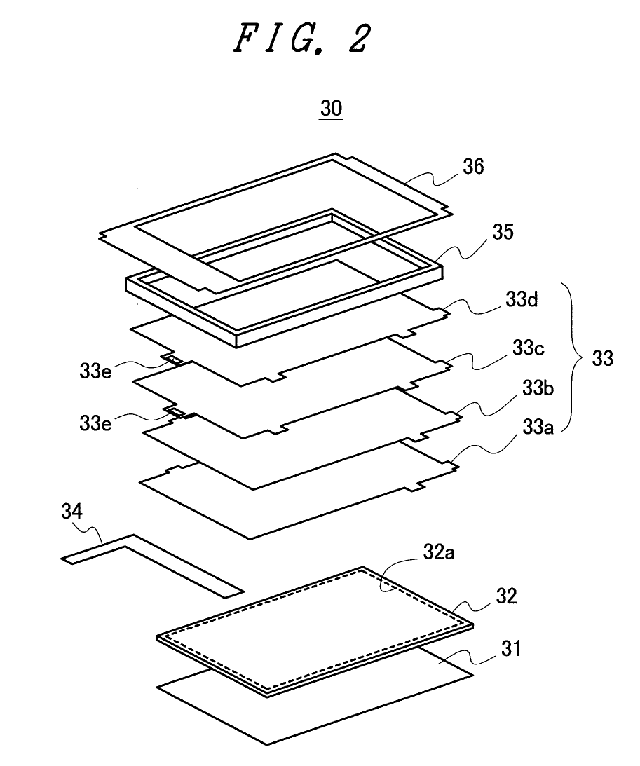

The backlight 30 includes, as shown in a perspective development of a key portion in FIG. 2, a reflective sheet 31; a light guide plate 32 disposed on the reflective sheet 31 and comprised of a flat light-transmitting polycarbonate plate having a thickness of approximately 0.3 to 0.4 mm, the light guide plate 32 having a light illuminating area 32a; and an optical compensation sheet laminate 33 disposed on the light guide plate 32, the optical compensation sheet laminate 33 formed by sequentially stacking a lower diffuser sheet 33a, a lower prism sheet 33b, an upper prism sheet 33c, an upper diffuser sheet 33d, and other members.

A flexible printed board 34 is disposed in the vicinity of a light introduction surface of the light guide plate 32. The flexible printed board 34 has a plurality of light emitting diodes and other components mounted thereon, and feeds electricity to the light emitting diodes. The reflection sheet 31, the light guide plate 32, the optical compensation sheet laminate 33, and the flexible printed board 34, each of which is a member of the laminate, are integrated in such a way that the overall shape of the integrated laminate has a substantially flat shape.

The laminate members, which include the reflection sheet 31, the light guide plate 32, the optical compensation sheet laminate 33, and the flexible printed board 34 having the light emitting diodes mounted thereon and are integrated in such a way that the overall shape of the integrated laminate has a substantially flat shape, are housed in a frame-shaped mold frame 35 comprised of a formed polycarbonate resin member. A frame-shaped, light-blocking, double-sided tape 36 is bonded to the front side of the mold frame 35. Specifically one surface (lower surface) of the tape 36 is bonded to the front side of the frame. The backlight is thus formed.

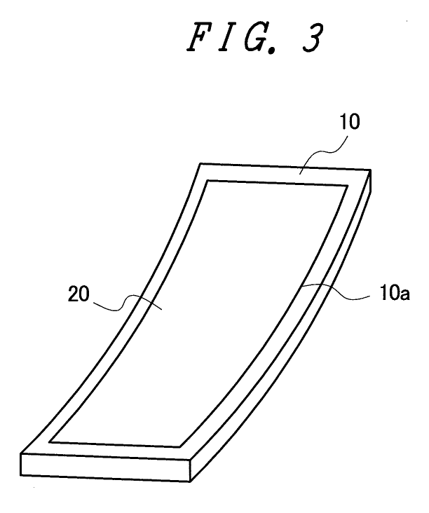

The components of the thus configured liquid crystal display device are assembled in the following manner: That is, the backlight 30 and the liquid crystal display panel 20, each of which has a flat shape, are stacked and housed in the lower frame 40 having a curved upper side, and pressed so that the backlight 30 and the liquid crystal display panel 20 follow the curved shape of the lower frame 40. The upper frame 10 having a curved upper side is then overlaid on the liquid crystal display panel 20 so that the upper frame 10 and the lower frame 40 sandwich the liquid crystal display panel 20 and the backlight 30. The assembly is thus integrated into a curved shape and held and secured. The liquid crystal display device having a fixed radius of curvature in which the effective display area of the liquid crystal display panel 20 is exposed through the opening 10a in the upper frame 10 can thus be manufactured, as shown in a perspective view of a key portion in FIG. 3. Although not illustrated, the upper and lower frames 10, 40 can be secured to each other, for example, by fitting, caulking, or screwing.

In such a configuration, since the liquid crystal display panel 20 and the backlight 30, each of which has a flat shape, are secured along the curved shapes of the upper and lower frames 10, 40, the liquid crystal display panel 20 and the backlight 30 exert spring back forces on the upper and lower frames 10, 40. The upper and lower frames 10, 40 therefore need to be mechanically strong to the extent that the frames can withstand the spring back forces.

To this end, the assembled light guide plate 32 and mold frame 35 made of polycarbonate or other resin materials in the flat-shaped backlight 30 undergo annealing at a temperature close to the softening point of the resin material (approximately 80° C.), so that the backlight 30 and other components are heated and formed into a curved shape substantially comparable to those of the upper and lower frames 10, 40. The spring back forces can thus be reduced. The backlight 30 can therefore be held in a stable manner, whereby a structure that holds and secures the backlight 30 over a long period can be provided.

According to such a configuration, after the flat liquid crystal display panel 20 formed by using glass polishing to make the pair of light-transmitting glass substrates thin is combined with the flat backlight 30, the assembly is bent along the curved upper and lower frames 10, 40. It is therefore not necessary at all to separately fabricate a curved backlight.

The above embodiment has been described with reference to the configuration in which the upper and lower frames 10, 40 are concavely curved along the longitudinal direction of the liquid crystal display panel 20, but the invention is not limited thereto. The same advantageous effect described above is also provided in a configuration in which the upper and lower frames 10, 40 are concavely curved along the short-side direction of the liquid crystal display panel 20.

The above embodiment has been described with reference to the case where the display surface of the liquid crystal display panel 20 has a concavely curved shape with a radius of curvature of approximately 150 to 200 mm along the longitudinal direction. The same advantageous effect is of course provided in a case where the display surface of the liquid crystal display panel 20 is convexly curved along the longitudinal direction. Further, the same advantageous effect described above is of course provided in a case where the display surface of the liquid crystal display panel 20 has a convexly curved shape with a radius of curvature of approximately 100 to 200 mm along the short-side direction.

The above embodiment has been described with reference to the case where the invention is applied to a liquid crystal display as a curved-surface display, but the invention is not limited thereto. The substantially same advantageous effect is of course provided in a case where the invention is applied to an organic electroluminescent display panel that is sandwiched between the upper frame 10 and the lower frame 40 to form a convex or concave curved shape.

The embodiment described above is not limited to a liquid crystal display and an organic electroluminescent display. The embodiment described above is of course applicable to any other structure as long as the structure is comprised of two or more bonded light-transmitting substrates that are bent into a curved-surface display.

The above embodiment has been described with reference to the case where the shape of the liquid crystal display panel is rectangular, but the invention is not limited thereto. The invention is of course applicable to a liquid crystal display panel having a triangular or higher-order polygonal shape or even a circular shape.

The above embodiment has been described with reference to the case where the backlight is a side light-type backlight using light emitting diodes, but the invention is not limited thereto. The invention is of course applicable to a case where the side light-type backlight is replaced with an overhead light-type backlight, or a case where the light emitting diodes are replaced with fluorescent discharge lamps as long as the fluorescent discharge lamps are arranged along a curved surface.

What is claimed is:

1. A liquid crystal display device comprising:
a frame-shaped first frame having an opening to expose an effective display area, the first frame having a curved shape having a predetermined curvature in one direction;
a liquid crystal display panel including a pair of light-transmitting substrates that encapsulate liquid crystal molecules, each of the light-transmitting substrates having a pixel selection electrode on the inner surface thereof, the liquid crystal display panel disposed on the backside of the first frame so that the liquid crystal display panel faces the opening;
a backlight disposed on the backside of the liquid crystal display panel and irradiating the backside of the liquid crystal display panel with light-source light, the backlight including a light guide plate, an optical compensation laminate, a frame-shaped resin frame, and at least one light source; and
a second frame disposed on the backside of the backlight, the second frame having a curved shape having a curvature comparable to the curvature of the first frame,
wherein the liquid crystal display panel and the backlight are sandwiched between the first frame and the second frame and held and secured along the curved shape.

2. The liquid crystal display device according to claim 1,
wherein the first and second frames are formed into the curved shape having the predetermined curvature along the longitudinal direction of the liquid crystal display panel.

3. The liquid crystal display device according to claim 1,
wherein the first and second frames are formed into the curved shape having the predetermined curvature along the short-side direction of the liquid crystal display panel.

4. The liquid crystal display device according to claim 1,
wherein each of the first and second frames is comprised of a formed metal plate.

5. The liquid crystal display device according to claim 1,
wherein each of the light-transmitting substrates is a glass substrate.

6. The liquid crystal display device according to claim 5,
wherein the thickness of each of the pair of the glass substrates having the liquid crystal molecules encapsulated therebetween is 0.2 mm or smaller.

7. The liquid crystal display device according to claim 1,
wherein the thickness of the light guide plate is 0.5 mm or smaller.

8. The liquid crystal display device according to claim 1,
wherein the light source is a light emitting diode, and the light emitting diode is disposed at an end of the light guide plate.
